(19) United States
(12) Patent Application Publication
(10) Pub. No.: US 2005/0287469 A1
(43) Pub. Date: Dec. 29, 2005

(54) Photosensitive composition for interlayer dielectric and method of forming patterned interlayer dielectric

(76) Inventors: Tatsuro Nagahara, Tokyo (JP); Hideki Matsuo, Tokyo (JP)

Correspondence Address: AZ ELECTRONIC MATERIALS USA CORP.;ATTENTION: INDUSTRIAL PROPERTY DEPT., 70 MEISTER AVENUE, SOMERVILLE, NJ, 08876, US

(21) Appl. No.: 10/521,644

(22) PCT Filed: May 27, 2003
(86) PCT No.: PCT/JP03/06613

§ 371 Date: Jan. 13, 2005

(30) Foreign Application Priority Data
Jul. 18, 2002 (JP) 2002-209957

(51) Int. Cl. G03C 1/492

(52) U.S. Cl. 430/270.1

(57) ABSTRACT

There is provided a photosensitive composition which possesses excellent storage stability and can yield an interlayer insulation film with an improved film thickness limit. The photosensitive composition is characterized by comprising: a modified polysilsesquiazane having a weight average molecular weight of 500 to 200,000 comprising basic constitutional units represented by formula —[SiR¹(NR²)_{1.5}]— wherein R¹'s each independently represent an alkyl group having 1 to 3 carbon atoms or a substituted or unsubstituted phenyl group; R²'s each independently represent hydrogen, an alkyl group having 1 to 3 carbon atoms, or a substituted or unsubstituted phenyl group, up to 50% by mole of the basic constitutional units having been replaced by a linking group other than the silazane bond; and a photoacid generating agent.

### TECHNICAL FIELD

The present invention relates to a photosensitive composition, particularly an improvement in a photodecomposable polysilsesquiazane composition that can yield a film which can be finely patterned with high resolution upon exposure to light, and a method for forming a patterned interlayer insulation film using this composition.

### BACKGROUND ART

In the manufacture of semiconductor devices and liquid crystal display devices, an interlayer insulation film is used. In general, an interlayer insulation film is formed by coating or deposition from a gaseous phase, and is then etched through a photoresist to form a pattern. In the case of a fine pattern, however, gaseous phase etching is used. This etching, however, suffers from problems of high apparatus cost and slow processing speed.

On the other hand, the interlayer insulation film is exposed to a high temperature above 400° C. during the device manufacture process. Therefore, organic resins as used in conventional resists cannot withstand the high temperature and thus cannot be used as the interlayer insulation film. Patterned silica-based ceramic films are known to be useful as a film, capable of meeting the above material requirement, excellent in heat resistance as well as in abrasion resistance, corrosion resistance, insulating properties, transparency and the like for semiconductor devices, liquid crystal display devices, printed circuit boards and the like.

In particular, when a patterned film is allowed to remain unremoved for use as an interlayer insulation film, the film preferably has low permittivity. In order to meet the above requirement, Japanese Patent Laid-Open No. 181069/2000 discloses a method for forming a patterned polysilazane film, comprising the steps of: forming a coating of a photosensitive polysilazane composition comprising polysilazane and a photoacid generating agent; exposing the coating pattern-wise to light; and dissolving and removing the coating in its exposed area. This publication also discloses a method for forming a patterned insulating film, comprising the step of subjecting the above patterned polysilazane film to standing in an ambient atmosphere or baking to covert the polysilazane film to a silica-based ceramic film.

Further, the applicant of this invention has found that a composition prepared by adding a water-soluble compound as a shape stabilizer to a photosensitive composition comprising a specific modified polysilsesquiazane and a photoacid generating agent can enhance the resolution and, in addition, can form a fine pattern of an interlayer insulation film possessing excellent permittivity and mechanical properties. The application has proposed the above finding as Japanese Patent Application No. 297107/2000. Specifically, the applicant has proposed a photosensitive composition for an interlayer insulation film, comprising: a modified polysilsesquiazane comprising basic constitutional units having a number average molecular weight of 100 to 100,000 and represented by formula —[SiR¹(NR²)_{1.5}]— and 0.1 to 100% by mole, based on the above basic constitutional units, of other constitutional units represented by formulae —[SiR¹₂NR²]— and/or [SiR¹₃(NR²)_{0.5}]— wherein R¹'s each independently represent an alkyl group having 1 to 3 carbon atoms or a substituted or unsubstituted phenyl group and R²'s each independently represent hydrogen, an alkyl group having 1 to 3 carbon atoms, or a substituted or unsubstituted phenyl group; a photoacid generating agent; and a water-soluble compound as a shape stabilizer. The applicant has further proposed a method for forming a patterned interlayer insulation film, characterized by comprising the steps of: forming a coating of the above photosensitive composition for an interlayer insulation film; exposing the coating pattern-wise to light; dissolving and removing the coating in its exposed area; and subjecting the residual patterned coating to standing in an ambient atmosphere or baking.

The use of the above-described photosensitive composition can eliminate the need to conduct gaseous phase etching and can form an interlayer insulation film having a fine pattern at a low cost. On the other hand, the photosensitive composition described in Japanese Patent Laid-Open No. 181069/2000 has a problem of storage stability. Further, when the above photosensitive compositions are used to form a thick interlayer insulation film, cracking is likely to occur. Therefore, an improvement in film thickness limit is desired. Further, in this case, it is also required that the film thickness limit be improved without sacrificing the photosensitivity of the photosensitive composition and the hardness of the formed interlayer insulation film.

### DISCLOSURE OF THE INVENTION

The present inventor has made extensive and intensive studies with a view to solving the above problems of the prior art and, as a result, has found that the replacement of a part of constitutional units of polysilsesquiazane by a linking group other than the silazane bond can enhance the storage stability of a photosensitive composition without sacrificing the photosensitivity of the photosensitive composition and the hardness of an interlayer insulation film formed from the photosensitive composition and that the selection of the alternative linking group can enhance the film thickness limit of the interlayer insulation film formed from the photosensitive composition. This has led to the completion of the present invention.

The constitution of the present invention will be described.

[1] A photosensitive composition for an interlayer insulation film, characterized by comprising: a modified polysilsesquiazane having a weight average molecular weight of 500 to 200,000 comprising basic constitutional units represented by formula —[SiR¹(NR²)_{1.5}]— wherein R¹'s each independently represent an alkyl group having 1 to 3 carbon atoms or a substituted or unsubstituted phenyl group; R²'s each independently represent hydrogen, an alkyl group having 1 to 3 carbon atoms, or a substituted or unsubstituted phenyl group, up to 50% by mole of said basic constitutional units having been replaced by a linking group other than the silazane bond; and a photoacid generating agent.

[21 The photosensitive composition for an interlayer insulation film according to the above item [1], wherein said modified polysilsesquiazane further comprises 0.1 to 100% by mole, based on said basic constitutional units, of other constitutional units represented by formula —[SiR³₂NR²]— and/or [SiR³₃(NR²)_{0.5}]— wherein R³'s each independently represent hydrogen, an alkyl group having 1 to 3 carbon atoms, or a substituted or unsubstituted phenyl group; and R²'s each independently represent hydrogen, an alkyl group having 1 to 3 carbon atoms, or a substituted or unsubstituted phenyl group.

[3] The photosensitive composition for an interlayer insulation film according to the above item [1] or [2], wherein said linking group is represented by formula (I): 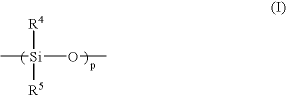
wherein R⁴ and R⁵ each independently represent hydrogen, or an alkyl, alkenyl, cycloalkyl, aryl, aralkyl, alkylamino, alkylsilyl, or alkoxy group; and p is an integer of 1 to 10.

[4] The photosensitive composition for an interlayer insulation film according to the above item [1] or [2], wherein said linking group is represented by formula (II): 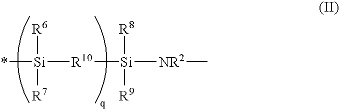
wherein R⁶, R⁷, R⁸, and R⁹ each independently represent an alkyl, alkenyl, cycloalkyl, aryl, aralkyl, alkylamino, alkylsilyl, or alkoxy group; R¹⁰ represents an oxygen atom or an alkylene, alkenylene, cycloalkylene, arylene, alkylimino, or alkylsilylene group; R²'s each independently represent hydrogen, an alkyl group having 1 to 3 carbon atoms, or a substituted or unsubstituted phenyl group; and q is an integer of 1 to 10.

[5] The photosensitive composition for an interlayer insulation film according to the above item [4], wherein R⁶, R⁷, R⁸, and R⁹ represent a methyl group, R¹⁰ represents a phenylene group, R² represents hydrogen, and q is 1.

[6] The photosensitive composition for an interlayer insulation film according to any one of the above items [1] to [5], wherein said photoacid generating agent is selected from the group consisting of sulfoxime compounds and triazine compounds.

[7] The photosensitive composition for an interlayer insulation film according to any one of the above items [1] to [6], which further comprises 0.1 to 40% by mass, based on the photosensitive composition, of a dissolution preventive selected from the group consisting of t-butoxycarbonylated catechol, t-butoxycarbonylated hydroquinone, di-t-butyl benzophenone-4,4′-dicarboxylate, and di-t-butyl 4,4′-oxydibenzolate.

[8] The photosensitive composition for an interlayer insulation film according to any one of the above items [1] to [7], which further comprises a nitro- or carbonic ester-containing water-soluble compound as a shape stabilizer.

[9] The photosensitive composition for an interlayer insulation film according to any one of the above items [1] to [8], which further comprises a sensitizing dye.

[10] A method for forming a patterned interlayer insulation film, characterized by comprising: forming a coating of a photosensitive composition for an interlayer insulation film, comprising a modified polysilsesquiazane and a photoacid generating agent, said modified polysilsesquiazane having a weight average molecular weight of 500 to 200,000 comprising basic constitutional units represented by formula —[SiR¹(NR²)_{1.5}]— wherein R¹'s each independently represent an alkyl group having 1 to 3 carbon atoms or a substituted or unsubstituted phenyl group, R²'s each independently represent hydrogen, an alkyl group having 1 to 3 carbon atoms, or a substituted or unsubstituted phenyl group, up to 50% by mole of said basic constitutional units having been replaced by a linking group other than a silazane bond; exposing said coating pattern-wise to light; dissolving and removing the coating in its exposed area; and subjecting the resultant patterned coating in an ambient atmosphere to standing or baking.

The present invention will be described in more detail.

### BEST MODE FOR CARRYING OUT THE INVENTION

The photosensitive composition for an interlayer insulation film according to the present invention is a polysilsesquiazane-type positive-working photoresist. Upon exposure of a coating of the photosensitive composition to light in a pattern-wise manner, Si—N bonds of the polysilsesquiazane in the exposure area of the coating are cleaved, and the cleaved parts are further reacted with moisture in an ambient atmosphere to give silanol (Si—OH) bonds. That is, when the coating after the exposure is developed, the photosensitive composition in its exposed area is dissolved and removed while the unexposed area stays on the substrate to form a pattern (a positive-working pattern). Thus, the photosensitivity of the polysilsesquiazane-type positive-working photoresist is relied upon the Si—N bonds as basic constitutional units of the polysilsesquiazane-type positive-working photoresist. Therefore, the replacement of a part of the Si—N bonds by a linking group other than the silazane bond reduces the number of Si—N bonds which are sites cleaved upon exposure. This is considered to result in lowered photosensitivity of the polymer per se. However, it has been found that, even when all the Si—N bonds are not converted to Si—OH bonds, in the subsequent development treatment, the exposed area is completely removed as a mass comprised of a plurality of basic constitutional units. That is, it has been found that, even when a part of the basic constitutional units of polysilsesquiazane is replaced by a nonphotosensitive bond other than the Si—N bond, the photosensitivity as the photoresist can be satisfactorily ensured without sacrificing the removability of the exposed area. Based on such finding, according to the present invention, the modification of polysilsesquiazane on a level, which does not sacrifice the photosensitivity of the photosensitive composition as a photoresist, can enhance the storage stability of the photosensitive composition and, at the same time, can realize an improvement in film thickness limit of an interlayer insulation film formed upon conversion of the photosensitive composition film to a ceramic while maintaining high hardness.

The modified polysilsesquiazane contained in the photosensitive composition for an interlayer insulation film according to the present invention comprises basic constitutional units represented by formula —[SiR¹(NR²)_{1.5}]—. Up to 50% by mole of the basic constitutional units have been replaced by a linking group other than the silazane bond. In the formula, R¹'s each independently represent an alkyl group having 1 to 3 carbon atoms or a substituted or unsubstituted phenyl group; and R²'s each independently represent hydrogen, an alkyl group having 1 to 3 carbon atoms, or a substituted or unsubstituted phenyl group. Preferably, R¹ represents a methyl or phenyl group, most preferably a methyl group. Preferably, R² represents hydrogen.

The linking group, by which up to 50% by mole of the basic constitutional units is replaced, may be one represented by formula (I): 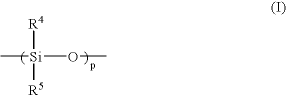
wherein R⁴ and R⁵ each independently represent hydrogen, or an alkyl, alkenyl, cycloalkyl, aryl, aralkyl, alkylamino, alkylsilyl, or alkoxy group; and p is an integer of 1 to 10. The replacement of the above basic constitutional units by this linking group can improve the storage stability of the photosensitive composition. The reason for this is believed to be as follows. In the case of polysilsesquiazane consisting of basic constitutional units in a trifunctional form alone, a number of distorted cyclic structures, which are cleaved during storage, are present in its molecule and cleaved parts recombine with similarly cleaved other molecules to increase the molecular weight. On the other hand, the replacement of a part of the basic constitutional units by a linking group other than the silazane bond can reduce the number of distorted cyclic structures. This is considered to suppress an increase in molecular weight caused by the above cleavage and recombination.

R⁴ and R⁵ generally represent an alkyl group having 1 to 7 carbon atoms, preferably 1 to 5 carbon atoms, more preferably 1 or 2 carbon atoms, an alkenyl group having 2 to 7 carbon atoms, a cycloalkyl group having 5 to 7 carbon atoms, or an aryl group. More specific examples of R⁴ and R⁵ include phenyl, tolyl, xylyl, cumenyl, benzyl, phenethyl, α-methylbenzyl, benzhydryl, trityl, styryl, cinnamyl, biphenyl, and naphthyl groups. The alkylsilyl group (mono-, di-, or tri-substituted), the alkylamino group (mono- or di-substituted), and the alkoxy group generally have 1 to 7 carbon atoms. R⁴ and R⁵ may be the same or different. p is preferably 1 to 5, most preferably 2.

According to the present invention, as described above, an enhancement in storage stability of the photosensitive composition and, at the same time, an enhancement in film thickness limit of an interlayer insulation film formed from the photosensitive composition without sacrificing the hardness of the interlayer insulation film can be realized by using, as the above linking group, a group represented by formula (II): 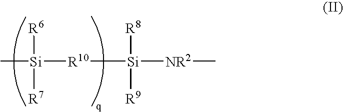
wherein R⁶, R⁷, R⁸, and R⁹ each independently represent an alkyl, alkenyl, cycloalkyl, aryl, aralkyl, alkylamino, alkylsilyl, or alkoxy group; R¹⁰ represents an oxygen atom or an alkylene, alkenylene, cycloalkylene, arylene, alkylimino, or alkylsilylene group; R²'s each independently represent hydrogen, an alkyl group having 1 to 3 carbon atoms, or a substituted or unsubstituted phenyl group; and q is an integer of 1 to 10.

R⁶, R⁷, R⁸, and R⁹ generally represent an alkyl group having 1 to 7 carbon atoms, preferably 1 to 5 carbon atoms, more preferably 1 or 2 carbon atoms (particularly a methyl group), an alkenyl group having 2 to 7 carbon atoms, a cycloalkyl group having 5 to 7 carbon atoms, or an aryl group. More specific examples of R⁶, R⁷, R8, and R⁹ include phenyl, tolyl, xylyl, cumenyl, benzyl, phenethyl, α-methylbenzyl, benzhydryl, trityl, styryl, cinnamyl, biphenyl, and naphthyl groups. The alkylsilyl group (mono-, di-, or tri-substituted), the alkylamino group (mono- or di-substituted), and the alkoxy group generally have 1 to 7 carbon atoms. R⁶, R⁷, R⁸, and R⁹ may be the same or different. R¹⁰ generally represents an alkylene group having 1 to 7 carbon atoms, preferably 1 to 5 carbon atoms, more preferably 1 or 2 carbon atoms, an alkenylene group having 2 to 7 carbon atoms, a cycloalkylene group having 5 to 7 carbon atoms, an arylene group, an alkylimino group having 1 to 7 carbon atoms, or an alkylsilylene group having 1 to 7 carbon atoms. More specific examples thereof include phenylene, tolylene, xylylene, benzylidene, phenethylidene, α-methylbenzylidene, cinnamylidene, and naphthylene groups. The arylene group is particularly preferably a phenylene group. Preferably, R² represents hydrogen. q is preferably 1 to 5, most preferably 1.

Up to 50% by mole of the basic constitutional units of the polysilsesquiazane has been replaced by the linking group other than the silazane bond. Effects of the present invention, that is, an improvement in storage stability of the photosensitive composition according to the present invention and an improvement in film thickness limit, can be attained by the presence of the linking group. Therefore, there is no need to specify the lower limit of the percentage replacement as a technical idea. In order to attain the effects of the present invention on a satisfactory level, however, in general, the percentage replacement of the basic constitutional units by the linking group is suitably not less than 0.1% by mole, preferably not less than 1% by mole. On the other hand, in general, the upper limit of the percentage replacement is suitably not more than 50% by mole, preferably not more than 45% by mole, more preferably not more than 40% by mole, from the viewpoint of avoiding the sacrifice of desired photosensitivity of the photosensitive composition for an interlayer insulation film. The form of replacement of the basic constitutional units by the linking group according to the present invention is random. Further, in the modified polysilsesquiazane according to the present invention, the linking group represented by formula (I) and the linking group represented by formula (II) may be present in a mixed form.

The modified polysilsesquiazane according to the present invention may further comprise 0.1 to 100% by mole, based on said basic constitutional units, of other constitutional units represented by formula —[SiR³₂NR²]— and/or [SiR³₃(NR²)_{0.5}]— wherein R³'s each independently represent hydrogen, an alkyl group having 1 to 3 carbon atoms, or a substituted or unsubstituted phenyl group; and R²'s each independently represent hydrogen, an alkyl group having 1 to 3 carbon atoms, or a substituted or unsubstituted phenyl group. As compared with the polysilsesquiazane comprised of trifunctional basic constitutional units alone, the replacement of the basic constitutional units by the difunctional constitutional units and/or the monofunctional constitutional units can suppress an increase in molecular weight of the polysilsesquiazane and can further enhance the storage stability of the photosensitive composition.

These other constitutional units are randomly bonded to the basic constitutional units. Each of R¹, R², and R³ may be independently selected. Therefore, each of these groups may be the same or different between basic constitutional units. Further, each of them may be the same or different between basic constitutional units and other constitutional units. For example, possible embodiments include one wherein, in the basic constitutional units, a part of R¹ represents methyl with the remaining R¹ representing phenyl, one wherein, in the basic constitutional units, a part of R² represents hydrogen with the remaining R² representing methyl, one wherein R¹ in the basic constitutional units represents methyl while R³ in other constitutional units represents methyl or phenyl, one wherein R² in the basic constitutional units represents hydrogen while R³ in other constitutional units represents hydrogen or methyl. Preferably, for both the basic constitutional units and the other constitutional units, R¹ and R³ represent a methyl or phenyl group, most preferably a methyl group. Further, for both the basic constitutional units and the other constitutional units, preferably, R² represents hydrogen.

The modified polysilsesquiazane comprising the above other constitutional units comprises 0.1 to 100% by mole, preferably 0.5 to 40% by mole, more preferably 1 to 20% by mole, based on the basic constitutional units, of other constitutional units represented by formula —[SiR³₂NR²]— and/or [SiR³₃(NR²)_{0.5}]—. When only constitutional units represented by formula —[SiR³₂NR²]— are contained as other constitutional units, the content of the constitutional units based on the basic constitutional units is preferably 0.1 to 100% by mole, more preferably 1 to 20% by mole. On the other hand, when only constitutional units represented by formula [SiR³₃(NR²)_{0.5}]— are contained as other constitutional units, the content of the constitutional units based on the basic constitutional units is preferably 0.1 to 50% by mole, more preferably 0.5 to 20% by mole. When the content of these other constitutional units exceeds 100% by mole, the molecular weight of the polymer is not satisfactorily high. Consequently, disadvantageously, the coating becomes fluid.

The weight average molecular weight of the modified polysilsesquiazane according to the present invention is in the range of 500 to 200,000, preferably 600 to 150,000. When the weight average molecular weight of the modified polysilsesquiazane is smaller than 500, the coating becomes fluid. On the other hand, when the weight average molecular weight of the modified polysilsesquiazane is larger than 200,000, the dissolution of the photosensitive composition in a solvent is difficult. Both the above cases are unfavorable.

The modified polysilsesquiazane according to the present invention can be easily prepared by, in ammonolysis for synthesizing conventional polysilazane, using, as starting materials, R¹SiCl₃ and a monomer, from which a linking group other than a silazane bond may be derived, so that the molar ratio of the monomer used corresponds to the replacement ratio of the linking group. For example, when the linking group to be incorporated is a group represented by formula (I), ammonolysis may be carried out using a silane starting material prepared by mixing Cl(Si(R⁴)(R⁵)O)ₚSi(R¹)Cl₂ into R¹SiCl₃. In this case, in calculating the molar ratio corresponding to the replacement ratio of the linking group, the numeric value p in the monomer should be taken into consideration because the Si(R¹)Cl₂ part of Cl(Si(R⁴)(R⁵)O)ₚSi(R¹)Cl ₂ is incorporated in the basic constitutional units. For example, in the case of p=1, when R¹SiCl₃ and ClSi(R⁴)(R⁵)OSi(R¹)Cl₂ are mixed together in a molar ratio of 1:1, the replacement ratio of the linking group is about 33%. In the case of p=2, when R¹SiCl₃ and Cl(Si(R⁴)(R⁵)O)₂Si(R¹)Cl₂ are mixed together in a molar ratio of 2:1, the replacement ratio of the linking group is 40%. On the other hand, when the linking group represented by formula (II) is contained as the linking group, ammonolysis may be carried out using a starting material prepared by mixing R¹SiCl₃ and Cl(Si(R⁶)(R⁷)R¹⁰)_{q}Si(R⁸)(R⁹)Cl in a molar ratio corresponding to the replacement ratio of the linking group independently of the q value. For example, when the former and the latter are mixed together in a molar ratio of 9:1, the replacement ratio of the linking group is 10%.

The modified polysilsesquiazane containing the above other constitutional units can be easily prepared by, in ammonolysis for synthesizing conventional polysilazane, using R¹SiCl₃, R¹₂SiCl₂ and/or R¹₃SiCl as starting materials so that R¹₂SiCl₂ and R¹₃SiCl are used in a molar ratio corresponding to the content ratio of the above other constitutional units. For example, when 20% by mole of constitutional units represented by formula —[SiR¹₂NR²]— is contained as other constitutional units, ammonolysis may be carried out using a silane starting material prepared by mixing 20% by mole of R¹₂SiCl₂ into R¹SiCl₃. Likewise, when 10% by mole of constitutional units represented by formula [SiR¹₃(NR²)_{0.5}]— is contained as other constitutional units, 10% by mole of R¹₃SiCl may be mixed into R¹SiCl₃.

For details of ammonolysis in synthesizing polysilazane, reference may be made, for example, to Japanese Patent Publication No. 16325/1988.

The photosensitive composition according to the present 5 invention contains a photoacid generating agent. The photoacid generating agent is brought into an excited state directly by exposure to light in its inherent photosensitive wavelength region. Alternatively, when a sensitizing dye is used, the photoacid generating agent is brought into an excited state indirectly by exposure to light in its wavelength region which can excite the sensitizing dye. The excited photoacid generating agent cleaves Si—N bonds in the modified polysilsesquiazane, and the cleaved parts are considred to be reacted with moisture in the atmosphere to give silanol (Si—OH) bonds. Since the silanol is soluble in a developer which will be described later, the coating of the photosensitive composition only in its light exposed area is dissolved and removed to provide positive-working patterning.

The photoacid generating agent may be a peroxide. Specific examples of peroxides as the photoacid generating agent include 3,3′,4,4′-tetra(t-butylperoxycarbonyl)benzophenone, t-butylperoxybenzoate, methyl ethyl ketone peroxide, cyclohexanone peroxide, methylcyclohexanone peroxide, methyl acetoacetate peroxide, acetylacetone peroxide, 1,1-bis(t-hexylperoxy)-3,3,5-trimethylcyclohexane, 1,1-bis(t-hexylperoxy)cyclohexane, 1,1-bis(t-butylperoxy)-3,3,5-trimethylcyclohexane, di-t-butylperoxy-2-methylcyclohexane, 1,1-bis(t-butylperoxy)cyclohexane, 1,1-bis(t-butylperoxy)cyclododecane, 2,2-bis(t-butylperoxy)butane, n-butyl 4,4-bis(t-butylperoxy)valerate, 2,2-bis(4,4-di-t-butylperoxycyclohexyl)propane, p-menthanehydroperoxide, diisopropylbenzenehydroperoxide, 1,1,3,3-tetramethylbutylhydroperoxide, cumene hydroperoxide, t-hexylhydroperoxide, t-butylhydroperoxide, α,α′-bis(t-butylperoxy)diisopropylbenzene, dicumyl peroxide, 2,5-dimethyl-2,5-bis(t-butylperoxy)hexane, t-butylcumyl peroxide, di-t-butyl peroxide, 2,5-dimethyl-2,5-bis(t-butylperoxy)hexyne-3, isobutylyl peroxide, 3,5,5-trimethylhexanoyl peroxide, octanoyl peroxide, lauroyl peroxide, stearoyl peroxide, succinic acid peroxide, m-toluoylbenzoyl peroxide, benzoyl peroxide, di-n-propylperoxydicarbonate, diisopropylperoxydicarbonate, bis(4-t-butylcyclohexyl)peroxydicarbonate, di-2-ethoxyethylperoxydicarbonate, di-2-ethylhexylperoxydicarbonate, di-3-methoxybutylperoxydicarbonate, di(3-methyl-3-methoxybutyl)peroxydicarbonate, α, α′-bis(neodecanoylperoxy)diisopropylbenzene, cumylperoxyneodecanoate, 1,1,3,3-tetramethylbutylperoxyneodecanoate, 1-cyclohexyl-1-methylethylperoxyneodecanoate, t-hexylperoxyneodecanoate, t-butylperoxyneodecanoate, t-hexyl peroxypivalate, t-butylperoxypivalate, 1,1, 3,3-tetramethylbutylperoxy-2-ethylhexanoate, 2,5-dimethyl-2,5-bis(2-ethylhexanoylperoxy)hexane, 1-cyclohexyl-1-methylethylperoxy-2-ethylhexanoate, t-hexylperoxy 2-ethylhexanoate, t-butylperoxy 2-ethylhexanoate, t-butylperoxyisobutyrate, t-hexylperoxyisopropylmonocarbonate, t-butylperoxymaleic acid, t-butylperoxy 3,5,5-trimethylhexanoate, t-butylperoxylaurate, 2,5-dimethyl-2,5-(m-toluoylperoxy)hexane, t-butylperoxyisopropylmonocarbonate, t-butyl peroxy 2-ethylhexylmonocarbonate, t-hexylperoxybenzoate, 2,5-dimethyl-2,5-bis(benzoylperoxy)hexane, t-butyl peroxyacetate, t-butylperoxy-m-toluoylbenzoate, bis(t-butyl peroxy)isophthalate, t-butylperoxyallylmonocarbonate, t-butyltrimethylsilyl peroxide, and 1,3-di(t-butylperoxycarbonyl)benzene.

The photoacid generating agent may be a naphthoquinonediazidosulfonic ester or a nitrobenzyl ester. Specific examples of naphthoquinonediazidosulfonic esters as the photoacid generating agent include 1,2-naphthoquinone-(2)-diazido-5-sulfonic acid chloride, 1,2-naphtoquinone-(2)-diazido-4-sulfonic acid chloride, an (mono- to tri-) ester of 2,3,4-trihydroxybenzophenon with 6-diazo-5,6-dihydro-5-oxo-naphthalene-1-sulfonic acid, and an (mono- to tri-) ester of 2,3,4,4′-trihydroxybenzophenon with 6-diazo-5,6-dihydro-5-oxo-naphthalene-1-sulfonic acid. Specific examples of nitrobenzyl esters as the photoacid generating agent include nitrobenzyl tosylate, dinitrobenzyl tosylate, nitrobenzyl chloride, dinitrobenzyl chloride, nitrobenzyl bromide, dinitrobenzyl bromide, nitrobenzyl acetate, dinitrobenzyl acetate, nitrobenzyltrichloroacetate, and nitrobenzyltrifluoroacetate. Other useful photoacid generating agents include benzoin tosylate, nitrobenzylsulfonic acids, and onium salts (for example, bis(4-t-butylphenyl)iodonium salt and triphenyl sulfonium salt). If necessary, these photoacid generating agents may be used in combination.

In the photosensitive composition according to the present invention, the photoacid generating agent is generally contained in an amount of 0.05 to 50% by mass based on the mass of the modified polysilsesquiazane. When the content of the photoacid generating agent is less than 0.05% by mass, the decomposition reaction rate is very low. On the other hand, when the content of the photoacid generating agent is more than 50% by mass, a dense film which is a modified polysilsesquiazane-derived feature cannot be formed without difficulties. The content of the photoacid generating agent is preferably 0.1 to 20% by mass, more preferably 1 to 20% by mass, based on the mass of the modified polysilsesquiazane.

When the photosensitive composition comprising the modified *polysilsesquiazane and the photoacid generating agent should be stored for a given period of time or longer, some photoacid generating agents including nitrobenzylsulfonic esters have a fear of being decomposed by a very small amount of NH₃ liberated from the modified polysilsesquiazane during storage. In this case, the selection of a base-resistant photoacid generating agent can improve the storage stability of the photosensitive composition. Base-resistant photoacid generating agents include iminosulfonate derivatives, disulfone derivatives, diazomethane derivatives, and other photoacid generating agents, for example, sulfoxime compounds such as 4-methoxy-α-((((4-methoxyphenyl)sulfonyl)oxy)imino)benzeneacetonitrile and triazine compounds such as compounds represented by the following formula.

1. A photosensitive composition for an interlayer insulation film, characterized by comprising: a modified polysilsesquiazane having a weight average molecular weight of 500 to 200,000 comprising basic constitutional units represented by formula —[SiR¹(NR²)_{1.5}]— wherein R¹'s each independently represent an alkyl group having 1 to 3 carbon atoms or a substituted or unsubstituted phenyl group; R²'s each independently represent hydrogen, an alkyl group having 1 to 3 carbon atoms, or a substituted or unsubstituted phenyl group, up to 50% by mole of said basic constitutional units having been replaced by a linking group other than the silazane bond; and a photoacid generating agent.

2. The photosensitive composition for an interlayer insulation film according to claim 1, wherein said modified polysilsesquiazane further comprises 0.1 to 100% by mole, based on said basic constitutional units, of other constitutional units represented by formula —[SiR³₂NR²]— and/or [SiR³₃(NR²)_{0.5}]— wherein R³'s each independently represent hydrogen, an alkyl group having 1 to 3 carbon atoms, or a substituted or unsubstituted phenyl group; and R²'s each independently represent hydrogen, an alkyl group having 1 to 3 carbon atoms, or a substituted or unsubstituted phenyl group.

3. The photosensitive composition for an interlayer insulation film according to claim 1 or 2, wherein said linking group is represented by formula (I): 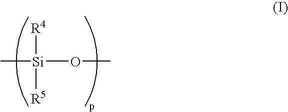
wherein R⁴ and R⁵ each independently represent hydrogen, or an alkyl, alkenyl, cycloalkyl, aryl, aralkyl, alkylamino, alkylsilyl, or alkoxy group; and p is an integer of 1 to 10.

4. The photosensitive composition for an interlayer insulation film according to claim 1, wherein said linking group is represented by formula (II): 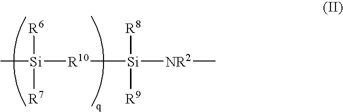
wherein R⁶, R⁷, R⁸, and R⁹ each independently represent an alkyl, alkenyl, cycloalkyl, aryl, aralkyl, alkylamino, alkylsilyl, or alkoxy group; R¹⁰ represents an oxygen atom or an alkylene, alkenylene, cycloalkylene, arylene, alkylimino, or alkylsilylene group; R²'s each independently represent hydrogen, an alkyl group having 1 to 3 carbon atoms, or a substituted or unsubstituted phenyl group; and q is an integer of 1 to 10.

5. The photosensitive composition for an interlayer insulation film according to claim 4, wherein R⁶, R⁷, R⁸, and R⁹ represent a methyl group, R¹⁰ represents a phenylene group, R² represents hydrogen, and q is 1.

6. The photosensitive composition for an interlayer insulation film according to claim 1, wherein said photoacid generating agent is selected from the group consisting of sulfoxime compounds and triazine compounds.

7. The photosensitive composition for an interlayer insulation film according to claim 1, which further comprises 0.1 to 40% by mass, based on the photosensitive composition, of a dissolution preventive selected from the group consisting of t-butoxycarbonylated catechol, t-butoxycarbonylated hydroquinone, di-t-butyl benzophenone-4,4′-dicarboxylate, and di-t-butyl 4,4′-oxydibenzolate.

8. The photosensitive composition for an interlayer insulation film according to claim 1, which further comprises a nitro- or carbonic ester-containing water-soluble compound as a shape stabilizer.

9. The photosensitive composition for an interlayer insulation film according to claim 1, which further comprises a sensitizing dye.

10. A method for forming a patterned interlayer insulation film, characterized by comprising: forming a coating of a photosensitive composition for an interlayer insulation film, comprising a modified polysilsesquiazane and a photoacid generating agent, said modified polysilsesquiazane having a weight average molecular weight of 500 to 200,000 comprising basic constitutional units represented by formula —[SiR¹(NR²)_{1.5}]— wherein R¹'s each independently represent an alkyl group having 1 to 3 carbon atoms or a substituted or unsubstituted phenyl group, R²'s each independently represent hydrogen, an alkyl group having 1 to 3 carbon atoms, or a substituted or unsubstituted phenyl group, up to 50% by mole of said basic constitutional units having been replaced by a linking group other than a silazane bond; exposing said coating pattern-wise to light; dissolving and removing the coating in its exposed area; and subjecting the resultant patterned coating in an ambient atmosphere to standing or baking.

11. The photosensitive composition for an interlayer insulation film according to claim 2, wherein said linking group is represented by formula (I): 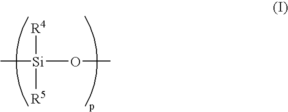
wherein R⁴ and R⁵ each independently represent hydrogen, or an alkyl, alkenyl, cycloalkyl, aryl, aralkyl, alkylamino, alkylsilyl, or alkoxy group; and p is an integer of 1 to 10.

12. The photosensitive composition for an interlayer insulation film according to claim 2, wherein said linking group is represented by formula (II): 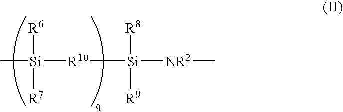
wherein R⁶, R⁷, R⁸, and R⁹ each independently represent an alkyl, alkenyl, cycloalkyl, aryl, aralkyl, alkylamino, alkylsilyl, or alkoxy group; R¹⁰ represents an oxygen atom or an alkylene, alkenylene, cycloalkylene, arylene, alkylimino, or alkylsilylene group; R²'s each independently represent hydrogen, an alkyl group having 1 to 3 carbon atoms, or a substituted or unsubstituted phenyl group; and q is an integer of 1 to 10.
